(19) United States
(12) Patent Application Publication
(10) Pub. No.: US 2014/0260172 A1
(43) Pub. Date: Sep. 18, 2014

(54) MULTI-FUNCTIONAL HAND RAKE

(71) Applicant: Warren C. Bowden, Paradise, CA (US)

(72) Inventor: Warren C. Bowden, Paradise, CA (US)

(21) Appl. No.: 14/286,293

(22) Filed: May 23, 2014

Related U.S. Application Data
(63) Continuation-in-part of application No. 13/343,757, filed on Jan. 5, 2012, now abandoned.

(51) Int. Cl. A01D 11/06; A01D 7/06

(52) U.S. Cl. CPC A01D 11/06; A01D 7/06
USPC 56/400.21; 294/52

(57) ABSTRACT

Systems and methods are disclosed for removing debris with a rake having a handle; a stabilizing brace; and a rake head secured to the handle. The rake head includes a mounting bar; and one or more pivotable double coiled spring tines positioned on the mounting bar, each spring tine having an attaching area placed in tension with a leading coil portion, wherein the coils are pressed against the mounting bar as the raked material urges the tine forwardly and wherein a connective area of the spring tine is pulled in the direction of an axis instead of bending transversely to the axis.

The present application claims priority to Provisional Application Serial No. 61/516,177 filed on Mar. 29, 2011 and Utility Application Ser. No. 13/343,757 filed Jan. 5, 2012, the contents of which are incorporated by reference.

### BACKGROUND OF THE INVENTION

The invention relates generally to rakes commonly used by homeowners, gardeners, landscapers, yard maintenance and various other individuals and more specifically it relates to a multi-functional hand rake with clog-free heavy-duty spring tines.

### DESCRIPTION OF RELATED ART

Garden leaf rakes are commonly used to rake leaves, pine needles, yard and garden clippings, etc. At times various users can use hand rakes to rake pine needles, leaves, yard and garden clippings. With prior art rakes currently in the market, such as the bamboo broom type design in U.S. Pat. No. 1,989,815, flexible steel tine leaf rakes U.S. Pat. Nos. 2,137,795 and 2,316,168, or molded plastic rakes, U.S. Pat. No. 6,640,531, the tines get clogged and the user must often stop raking and clear the tines of this clogged material. Then when the user wishes to dispose the raked material, the user uses another tool, such as a pitchfork, to remove the raked material to a disposal container. When pine needles, leaves, yard and garden clippings, etc., get wet, the prior art tools clog faster and make the task of removing this debris more labor intensive. It is understandable that these methods are inadequate at times due to the fact that the user must expend more energy and use more than one tool to accomplish the task.

The use of certain prior art products such as the rake Riley and Michael, U.S. Pat. No. 6,640,531 B1, does rake pine needles. However, this rake is constructed with thin-coiled tines (approx. 1/16″ diameter) that easily clog due to the spacing of the tines. The user must stop and clean the tines frequently thereby taking more time to complete the task. These flimsy, flexible tines over a period of time will overlap each other and lose its effectiveness. Likewise, the U.S. Pat. No. 6,640,531 B1 rake cannot move a pile of raked material nor can it pick up raked material and place this material into a disposal container. This rake, U.S. Pat. No. 6,640,531 B1, is also not effective when raking wet pine needles, leaves, yard and garden clippings. Due to the thin 1/16″ diameter tines and plastic rake head, this rake is not heat resistant. In addition, the use of garden leaf rakes to remove pine needles, leaves, yard and garden clippings can be extremely laborious as these rakes are not able to rake through ornamental pebbles, ground cover, etc. They also are not able to carry debris over obstacles such as bigger rocks, tree roots, etc. A multi-functional hand rake that overcomes the numerous problems associated with prior art would be valuable to these trades and many others.

### SUMMARY

In one aspect, systems and methods are disclosed for removing debris with a rake having a handle; a stabilizing brace; and a rake head secured to the handle. The rake head includes a ¾″ diameter round mounting bar and measures 28″ or less in length; and five or less double pivotable teeth each with more than three 1 9/16″ diameter spring coils that encircle the mounting bar before becoming two bent tines with the same orientation. These heavy-duty teeth are comprised of 0.187 gauge tempered steel wire with two 7″ tines, each having two 1½″ bends, one at a 46.2° angle at the coiled end and the other a 26.5° angle at the tip of the tine. Tines are spaced 2¾″ apart. The double pivotable teeth are positioned on the mounting bar with all tines spaced at 2¾″ apart. This double pivotable teeth with heavy-duty gauge wire, its coils and bends, and its spacing on the mounting bar along with the stabilizing support brace allow for a clog-free raking experience. The thicker gauge wire tines will not overlap each other; the spring coils will allow the rake to go over small rocks, plants, decorative rocks and gravel without removing said items while continuing to rake material; the bends on the tines allow for material to roll within the teeth; and the spacing of the tines on the rake head allow material to not clog while raking. Raked material can be pushed into large piles with the oversized rake head and when turned on to its back side, the rake then becomes a pitchfork. The attaching area of each of the teeth is placed in tension with a leading coil portion, wherein the coils are pressed against the mounting bar as the raked material urges the tine forwardly and wherein a connective area of the spring tine is pulled in the direction of an axis instead of bending transversely to the axis, wherein spring tines roll raked materials and pivot to avoid obstacles.

In another aspect, a method for removing yard debris includes pulling on a handle with a rake head secured to the handle, the handle having a mounting bar and one or more pivotable spring coils positioned on the mounting bar with spring tines extending from the coils; compressing the coils as the yard debris urges the spring tines forwardly while the handle is being pulled; and pivoting the spring tines over obstacles to sweep yard debris without clogging the spring tines.

In yet another aspect, a method for removing yard debris includes pulling on a handle with a rake head secured to the handle, the handle having a mounting bar and one or more pivotable double coiled spring tines positioned on the mounting bar, each spring tine having an attaching area placed in tension with a leading coil portion, wherein the coils are pressed against the mounting bar as the raked material urges the tine forwardly and wherein a connective area of the spring tine is pulled in the direction of an axis instead of bending transversely to the axis; and sweeping the debris without clogging the tines.

Implementations of the rake can include one or more of the following. The preferred embodiment is made with an attaching section of the tine that is placed in tension with the leading portion of each coil pressed against the mounting bar as the raked material urges the tine forwardly. The connection portion of the tine is pulled in the direction of its axis rather than being bent transversely to its axis. The tines of the preferred embodiment will not overlap. Other implementations can include one or more of the following:

1) Provide an improved multi-functional hand rake;

2) Provide a multi-functional hand rake that will save up to 75% of one's time when manually raking up, piling up, and moving pine needles, leaves, thatch, yard and garden clippings, etc.;

3) Provide a multi-functional hand rake that will not clog the tines of the rake;

4) Provide a multi-functional hand rake that consists of heavy-duty spring tines on the rake head that will pivot both forwardly and rearwardly about the axis of the coil-connecting portion while in contact with the ground;

5) Provide a multi-functional hand rake that has a spring mounting means which reduces the bending load of the tine in the area of its connection to the mounting bar, and which maintains the area in true tension rather than bending during operation.

6) Provide a multi-functional hand rake that provides a means for pivotally attaching a heavy duty spring tine to a mounting bar in which the pivot area of the tine is attached to the bar in a manner that allows the tine to freely return to the working position after hitting an object or after the rake is reversed and the tine is pivoted upwardly.

7) Provide a multi-functional hand rake that uproots dead, matted grass and dislodge hard-packed dirt for planting with efficient heavy-duty tines.

8) Provide a multi-functional hand rake that is able to rake wet pine needles, leaves, yard and garden clippings without clogging of its tines.

9) Provide a multi-functional hand rake that can be used to pick up pine needles, leaves, yard and garden clippings efficiently, e.g. as a pitchfork.

The preferred embodiments with the accompanying drawings are illustrative only, and that changes may be made in the specific construction illustrated and to broadly state the methodologies that may be used in order to more effectively accomplish the task of raking, piling, and moving pine needles, leaves, yard and garden clippings by using one tool instead of several thereby saving the user a great amount of time and energy.

Advantages of the rake may include one or more of the following. The rake is a heavy-duty rake that can rake pine needles, leaves, yard and garden clippings, etc., without clogging. It will rake, pile, and move either dry or wet material effectively. The preferred embodiment can rake through ornamental pebbles, ground cover, etc., and rake over larger rocks and tree roots while maintaining debris in its tines. Due to its construction, the preferred embodiment is heat resistant. Additional benefits to the preferred embodiment are that the tines turn up dried grass, weeds, and soil in swathes the size of the rake head. Loosening heavy thatch and compacted dirt allows water to penetrate deeper and enhances drainage while letting in vital oxygen. Without these elements, grass and soil can become prone to disease and insect- and pest-related problems.

### BRIEF DESCRIPTION OF THE DRAWINGS

Various other objects, features and attendant advantages of the preferred embodiment will become fully appreciated as the same becomes better understood when considered in conjunction with the accompanying drawings, in which like reference characters designate the same or similar parts throughout the several views, and wherein:

FIG. 1 is a lower front perspective view of the rake constructed in accordance with the preferred embodiment.

FIG. 2 is a partial top view of the handle attached to the rake head. It also shows how the support brace is attached to the handle.

FIG. 3 is a partial back view of the rake head showing two double-coil spring tines mounted on to the tubular bar of the rake head.

FIG. 4 is a side view of the preferred embodiment showing the tine mounted on to the tubular bar of the rake head, angle support brace, and handle, while FIG. 5 shows a perspective view of the double-coil spring tine by itself.

### DETAILED DESCRIPTION OF THE INVENTION

### A. Description of the Preferred Embodiments

Turning now descriptively to the drawings, in which similar reference characters denote similar elements throughout the several views, the figures illustrate the rake head, support brace, and handle.

As shown in the drawings, the rake head consists of a tubular bar. This bar material may be treated steel, copper, etc. The tines are heavy-duty tempered steel spring tines, e.g., double coiled spring tines commonly used on harvesters that are attached to the tubular bar with fasteners such as bolts, nuts, and washers. As shown herein, there is a lag screw with washer that joins the handle to the tubular bar. This rake head may be heat resistant and may be used to rake pine needles, leaves, garden clippings, etc., including disposal in to burning piles.

The rake (10) includes a rake head (18) with an attachment portion (14) that consists of a lag screw and washer for receiving the handle (13) for the rake (10). The handle end cap (19) is provided for permitting the fastener assembly (14) to hold the handle (13) solidly on to the tubular portion of the rake head (18) as shown in FIG. 2.

Referring to FIGS. 1, 3 and 4, it is noted that the rake head (18) consists of several heavy duty, spring tines (17) attached to the tubular bar of the rake head (18) with fasteners (12) consisting of a bolt, washer, lock washer, and nut. The heavy-duty configuration illustrated in FIGS. 1, 3 and 4 are generally excellent for all raking operations including the uprooting of dead matted grass, soil conditioning and so on.

The rake may be constructed with a shorter handle, smaller rake head and/or lighter duty spring tines and so on. FIG. 5 shows a perspective view of the double-coil spring tine by itself. The rake also may be made with a wider rake head or any number of suitable configurations. Alternatively, a torsion spring can be used as a flexible elastic object that stores mechanical energy when it is twisted. The amount of force (actually torque) it exerts is proportional to the amount it is twisted. A helical torsion spring, is a metal rod or wire in the shape of a helix (coil) that is subjected to twisting about the axis of the coil by sideways forces (bending moments) applied to its ends, twisting the coil tighter.

The rake will easily pile raked pine straw, leaves, yard debris and the like. When the rake is turned over to its flat side, it will effectively move those raked piles. It may also be used to unload piles of yard debris off a truck or flatbed rather effectively and efficiently.

The support brace may be metal or any other generally rigid material. This brace connects the handle to the rake head and provides stability and strength.

In FIGS. 1 and 2, the support brace (11) is attached to the handle (13) with a fastener assembly (15) that consists of a bolt, washer, lock washer, and nut. It is attached to the rake head (18) with assembly (12) consisting of a bolt, washer, lock washer, and nut. Any other suitable means of attachment may be used, e.g. a form-fit wrap-around brace connection may be used as a substitute providing stability to the rake head.

The handle of the rake may be wood, fiberglass, metal and so on but not limited to these materials. Typically, there is a metal end cap at the point where the handle is attached to the tubular bar of the rake head. This end cap prevents the splitting of the handle material. The function of the handle is self-explanatory.

Any standard handle with end cap that may be purchased at any garden supply or hardware store may be used as a suitable replacement.

The rake head (18) is connected to the handle (13) as illustrated in FIGS. 1 and 2 of the drawings. The rake head may be connected to the handle (13) via various conventional attachment methods commonly utilized to manufacture rakes.

The support brace (11) is attached to the rake head (18) as shown in FIGS. 1 and 2 of the drawings. The support brace is preferably positioned at the metal end cap of the handle (13) and at a proper angle to the rake head (18) for optimal support of the rake head (18).

### B. Description of the Preferred Embodiment Prepared For Use

The user would hold the handle (13) of the rake (10) as a user would hold any other prior art manual rake. When the user pulls on the rake (10), the spring tines (17) on the rake head (18) will pivot and make a clean sweep of the pine straw, leaves, yard clippings, and the like without clogging the tines (17). The bigger the tines, the more resistance, the better it works. It may even pivot out of the way going over rocks or tree roots and so on. The unique ability of the tine's pivot and its bends are what provides an efficient and clean scooping action. The flexibility of the heavy duty, spring tines of the rake head (18) allows the rake (10) to easily and effectively maneuver over most terrains as it collects material thereby saving the user much time and effort. After several sweeps of the rake (10), the user can then pile the material collected. By turning the rake head (18) on to its flat side, the user may then efficaciously move the raked material into large piles. The user may effectively make even larger piles by using the rake head (18) very much like a pitchfork to lift the raked material.

### C. Method of Use

Once all of the parts are fully assembled as is shown in FIG. 1, the rake may be used by simply putting the rake down on the ground and while applying very little pressure on the handle, the user pulls the rake toward him or behind him rather than using a sweeping motion. The weight of the rake, the pivot of its tines and its bends are what provides efficient raking of pine straw, leaves, yard clippings, and the like without clogging the tines.

### D. Method of Manufacture (May Include the Associated Process)

In FIG. 4, the preferred embodiment is made with heavy-duty tempered double pivotable multi-coiled spring teeth with 0.187 gauge wire. The length and the bends of the tines are unique design of this rake's functionality.

### E. Variations

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

The spirit of the preferred embodiment provides a breadth of scope that includes all methods of making and using it. Any variation on the theme and methodology of accomplishing the same that are not described herein would be considered under the scope of the preferred embodiment.

What is claimed is:

1. A rake, comprising:
a handle;
a stabilizing brace;
a rake head secured to the handle, the rake head including a mounting bar with about ¾-inch diameter and measures 28″ or less in length; and
five or less double pivotable teeth each with more than three 1 9/16″ diameter spring coils that encircle the mounting bar before becoming two bent tines with the same orientation, each tooth comprised of about 0.2 gauge tempered steel wire with two 7″ tines, each having two 1½″ bends, one at about 46° angle at the coiled end and the other at about 26° angle at the tip of the tine, wherein the tines are spaced at about 2¾ inch apart and wherein the double pivotable teeth are positioned on the mounting bar with all tines spaced at about 2¾ inch apart, wherein the spacing of the tines allows material to not clog while raking and when turned on to a back side, the rake becomes a pitchfork, wherein an attaching area of each tooth is placed in tension with a leading coil portion, wherein the coils are pressed against the mounting bar as the raked material urges the tine forwardly and wherein a connective area of the spring tine is pulled in a direction of an axis instead of bending transversely to the axis, wherein spring tines roll raked materials and pivot to avoid obstacles.

2. The rake of claim 1, wherein the rake head and spring tines are heat resistant.

3. The rake of claim 1, wherein the spring tines pivot forwardly and rearwardly about an axis of a coil-connecting portion while in contact with the ground.

4. The rake of claim 1, comprising spring mounting means to reduce bending load on the tines in the connective area to the mounting bar, and which maintains the attaching area under tension instead of bending during operation.

5. The rake of claim 1, wherein the mounting bar comprises a pivot area attached to the spring tines that allows the spring tines to freely return to a working position after hitting an object or after the rake is reversed and the spring tine is upwardly pivoted.

6. The rake of claim 1, wherein the spring tines uproot dead, matted grass and dislodge hard-packed dirt for planting.

7. The rake of claim 1, wherein the spring tines are separated by a predetermined spacing to allow raking of wet pine needles, leaves, yard and garden clippings without clogging.

8. The rake of claim 1, wherein the spring tines form a pitchfork used to pick up pine needles, leaves, yard and garden clippings.

9. The rake of claim 1, wherein the spring tines are non-overlapping.

10. The rake of claim 1, wherein the two bends of each spring tine rolls a material being collected and gathers the material within the rake head.

11. A method for removing yard debris, comprising:
pulling on a handle with a rake head secured to the handle, the handle having a mounting bar and one or more pivotable spring coils positioned on the mounting bar with spring tines extending from the coils;
compressing the coils as the yard debris urges the spring tines forwardly while the handle is being pulled; and
pivoting the spring tines over obstacles to sweep yard debris without clogging the spring tines.

12. The method of claim 11, wherein the rake head and spring tines are heat resistant.

13. The method of claim 11, comprising pivoting the spring tines forwardly and rearwardly about the axis of a coil-connecting portion while in contact with the ground.

14. The method of claim 11, comprising
mounting the spring tines to reduce a bending load of the tine in the connective area to the mounting bar, and
maintaining the attaching area under tension instead of bending during operation.

15. The method of claim 11, wherein the spring tines freely return to a working position after hitting an object or after the rake is reversed and the spring tine is upwardly pivoted.

16. The method of claim 11, comprising uprooting dead, matted grass and dislodge hard-packed dirt for planting with the spring tines.

17. The method of claim 11, wherein the spring tines are separated by a predetermined spacing to rake wet pine needles, leaves, yard and garden clippings without clogging the spring tines.

18. The method of claim 11, wherein the tines and handle form a pitchfork used to pick up pine needles, leaves, yard and garden clippings.

19. The method of claim 11, wherein the spring tines are non-overlapping.

20. The method of claim 11, comprising pulling the rake and applying a weight of the rake and a light pressure to the handle to gather pine needles, leaves, yard and garden clippings.
